(19) United States
(12) Patent Application Publication
(10) Pub. No.: US 2003/0003326 A1
(43) Pub. Date: Jan. 2, 2003

(54) Recording medium and process for manufacturing the medium

(75) Inventors: Koichi Iida, Kawasaki (JP); Yuzuru Yamakage, Kawasaki (JP); Takahiro Umada, Kawasaki (JP); Mineo Moribe, Kawasaki (JP)

Correspondence Address: Patrick G. Burns, Suite 2500, 300 South Wacker Drive, Chicago, IL, 60606, US

(73) Assignee: Fujitsu Limited, Kawasaki-shi (JP)

(21) Appl. No.: 10/228,550

(22) Filed: Aug. 27, 2002

Related U.S. Application Data
(62) Division of application No. 09/627,338, filed on Jul. 28, 2000.

(30) Foreign Application Priority Data
Jul. 30, 1999 (JP) 11-216300
Jul. 12, 2000 (JP) 2000-211148

(51) Int. Cl. G11B 5/82

(52) U.S. Cl. 428/694 SG

(57) ABSTRACT

A recording medium suitable for magnetic super resolution reproduction and a process for manufacturing the medium are provided, in which land and groove recording is adopted and an intensity of a magnetic field for reproduction is reduced. The recording medium has the land and the groove, both of which are used for recording information. At least one of the land and the groove has an edge portion whose radius of curvature is greater than one sixth of the width of the land or the groove. The radius of curvature of the edge portion is enlarged by the process such as spatter etching of the substrate, deformation of a resist pattern by heating, ozone etching by ultraviolet rays.

### BACKGROUND OF THE INVENTION

1. Field of the Invention

The present invention relates to a recording medium having lands and grooves for recording information formed on a substrate, particularly a magnetic super resolution recording medium that utilizes a magnetic super resolution method for reproducing the recorded information, and to a process for manufacturing the medium.

2. Description of the Prior Art

The magnetic super resolution method is used for reading a recorded mark that is smaller than the diffraction limitation of a laser beam by irradiating a laser beam and by applying a magnetic field. The marks of information are recorded on a magnetic super resolution recording medium having a multilayered magnetic film by irradiating a laser beam and by applying a magnetic field. This method can enhance a recording density of a magneto-optic recording medium so as to support a large-capacity that is required to a recording medium along with a rapid progress in recent technology of a personal computer and its peripheral.

The magnetic super resolution method includes some variations. For example, the double mask RAD method, which is disclosed in Japanese unexamined patent publication No. 7-244877, uses two magnetic masks, i.e., a front mask and a rear mask. The front mask is an area of relatively low temperature heated by irradiation of laser beam, while the rear mask is an area that is heated to the highest temperature by the irradiation of laser beam. In these mask areas of the multilayered magnetic film, the magnetized information cannot be transferred from a recording layer to a reproducing layer. The transfer of the magnetized information from the recording layer to the reproducing layer can be performed only in the intermediate temperature area located between the two mask areas, so that the magnetized information can be reproduced.

In order to support recent higher recording density and larger capacity, it is under research to apply land and groove recording to the above-mentioned magnetic super resolution recording medium. In the land and groove recording, information is recorded on both the land and the groove. Here, the land is a protruding line portion that has been used for recording information, and the groove is a portion between the lands.

A recording medium (e.g., a magneto-optic disk) including the above-mentioned magnetic super resolution recording medium is usually manufactured by the following process. First, a photoresist is applied to a glass master disk and exposured by a laser beam so as to form a groove and pit pattern. The glass master disk is developed so that the exposed portion is removed, and a pitted surface is formed.

Next, an electrode film is formed on the pitted surface by utilizing a vapor deposition method, an electroless plating method or a spattering method, followed by electroforming so that a stamper is manufactured. Then a replica is manufactured from the stamper by an ultraviolet curable resin method (i.e., a photopolymer method or a 2P method) or by an injection molding method. This conventional process can hardly control the radius of curvature of the edge portion of the land or the groove as well as a wall angle.

There is a problem that an intensity of a magnetic field that is necessary for reproducing information becomes larger when the above-mentioned land and groove recording is applied to the magnetic super resolution recording medium. Especially, when the land and groove recording method is applied to the above-mentioned double mask RAD method, the magnetic field that is necessary for generating the front mask becomes above 500 Oe. As a result, a power consumption of a coil for generating the magnetic field and a driving circuit of the coil increases. Otherwise, a substantial engineering change of the coil for generating the magnetic field is required.

### SUMMARY OF THE INVENTION

The object of the present invention is to provide a recording medium that can reduce the increase of the magnetic field that is necessary for reproduction and is suitable for the magnetic super resolution reproduction and a process for manufacturing the medium.

A recording medium according to the present invention has lands and grooves formed on a substrate for recording information. At least one of the land and the groove has an edge portion whose radius of curvature is greater than one sixth of the width of the land or the groove. Preferably, the recording medium is a magnetic super resolution recording medium from which recorded information is reproduced by a magnetic super resolution method.

By rounding the shape of the edge portion as mentioned above, it was verified in the experiment that the intensity of the magnetic field to be applied for reproduction by the magnetic super resolution method could be decreased. One of the reasons is that a heat distribution shape of the laser irradiated portion may change by rounding the shape of the edge portion. Another reason is that a thickness of the magnetic recording film can be uniform if the radius of curvature of the edge portion is large. It is found that the radius of curvature of the edge portion of the groove affects greater than that of the land.

A first process of the present invention for manufacturing the recording medium comprises the steps of forming a resist pattern on a substrate that can be processed by plasma etching utilizing a photolithography method, using the resist pattern as a mask for dry etching, etching the substrate by spattering after removing a residual resist pattern so as to enlarge a radius of curvature of an edge portion of a groove, making a stamper to which the shape of the etching pattern is transferred, making a substrate of a recording medium using the stamper, and forming a recording film on the substrate of the recording medium.

According to this process, a magnetic super resolution recording medium having a groove whose radius of curvature of the edge portion is greater than one sixth of the width of the land or the groove. Though this process is suitable for manufacturing the above-mentioned magnetic super resolution recording medium, it can be also used for manufacturing other kinds of recording medium. It is true for the following processes, too.

A second process of the present invention for manufacturing a recording medium comprises the steps of forming a resist pattern on a substrate utilizing a photolithography method, deforming the resist pattern by heat, making a stamper to which the shape of the resist pattern is transferred, using the stamper for making a substrate of a recording medium, and forming a recording film on the substrate of the recording medium.

A third process of the present invention for manufacturing a recording medium comprises the steps of forming a resist pattern on a substrate that can be processed by plasma etching utilizing a photolithography method, using the resist pattern as a mask for dry etching, etching the substrate by spattering after removing a residual resist pattern so as to enlarge a radius of curvature of an edge portion of a groove, making a first stamper to which the shape of the etching pattern is transferred, making a second stamper to which the shape of the first stamper is transferred, using the second stamper for making a substrate of a recording medium, and forming a recording film on the substrate of the recording medium.

A fourth process of the present invention for manufacturing a recording medium comprises the steps of forming a resist pattern on a substrate utilizing a photolithography method, deforming the resist pattern by heat, making a first stamper to which the shape of the resist pattern is transferred, making a second stamper to which the shape of the first stamper is transferred, using the second stamper for making a substrate of a recording medium, and forming a recording film on the substrate of the recording medium.

A fifth process of the present invention for manufacturing a recording medium comprises the steps of irradiating a master disk having a pitted surface shape with ultraviolet rays emitted by a low voltage mercury lamp so as to enlarge a radius of curvature of an edge portion of the pitted surface shape, using the master disk having the enlarged radius of curvature at the edge portion so as to make a stamper, using the stamper for making a substrate of a recording medium, and forming a recording film on the substrate of the recording medium.

It is preferable that the wavelength of the ultraviolet rays emitted from the low voltage mercury lamp be less than 254 nm.

The master disk is preferably manufactured by the process comprising the steps of forming a pitted surface shape on a resist pattern utilizing a photolithography method, forming an electrode film on the pitted surface, making a stamper by electroforming with the electrode film, and using the stamper for transferring the pitted surface shape to an ultraviolet curable resin. Thus, the master disk can be duplicated.

Another preferable process for manufacturing the master disk comprises the steps of forming a pitted surface shape on a resist pattern utilizing a photolithography method, forming an electrode film on the pitted surface, making a stamper by electroforming with the electrode film, and using the stamper for transferring the pitted surface shape by resin molding. Thus, the master disk can be duplicated.

A sixth process of the present invention for manufacturing a recording medium comprises the steps of applying a photoresist on a substrate and making an intermediate layer by performing a predetermined deactivation process to the photoresist, applying another photoresist to be a pitted surface layer on the intermediate layer, forming a pitted surface shape on the pitted surface layer utilizing a photolithography method, enlarging a radius of curvature of an edge portion of the pitted surface shape by a predetermined process, making a stamper by using a master having the edge portion of the pitted surface shape whose radius of curvature was enlarged, using the stamper for making a substrate of a recording medium, and forming a recording film on the substrate of the recording medium.

It is preferable that the deactivation process be a baking process under a temperature higher than the pre-baking temperature, whereby the intermediate layer changes the properties so as not to be mixed with the photoresist of the pitted surface layer and so as to lose the photosensitivity.

It is also preferable that the process for manufacturing a recording medium further comprises the step of performing a baking process to the pitted surface layer after forming the pitted surface shape of the resist pattern, and that the baking process be the same as that of the deactivation process.

In the step of making an intermediate layer, the photoresist can be replaced with an ultraviolet curable resin, which is applied and cured to be the intermediate layer.

It is also preferable that in the process for enlarging the radius of curvature of the edge portion of the pitted surface shape, the exposed surface of the intermediate layer be also processed.

In one embodiment, the process for enlarging the radius of curvature of the edge portion of the pitted surface shape is an ozone etching process by ultraviolet rays having a wavelength less than 254 nm emitted from a low voltage mercury lamp.

In another embodiment, the process for enlarging the radius of curvature of the edge portion of the pitted surface shape is a spatter etching process.

In another embodiment, the process for enlarging the radius of curvature of the edge portion of the pitted surface shape is a heating process at a temperature close to the glass transition temperature.

### BRIEF DESCRIPTION OF THE DRAWINGS

FIG. 1 is a magnified view showing a structure of lands and grooves of a magnetic super resolution recording medium according to the present invention.

FIG. 2 is a magnified view showing another structure of lands and grooves of a magnetic super resolution recording medium according to the present invention.

FIG. 3 shows a process for manufacturing a recording medium according to a first embodiment of the present invention.

FIG. 4 is a graph showing a magnetic field for generating a mask in the reproduction by the magnetic super resolution method when altering the radius of curvature of the edge portion of the groove.

FIG. 5 shows a process for manufacturing a recording medium according to a second embodiment of the present invention.

FIG. 6 shows a process for manufacturing a recording medium according to a third embodiment of the present invention.

FIG. 7 is a graph that shows the relationship between the irradiation time of the ultraviolet rays in the step (i) and the radius of curvature of the edge portion or an inclining angle of the wall.

FIG. 8 shows a process for manufacturing a recording medium according to a fourth embodiment of the present invention.

FIG. 9 is a graph that shows the relationship between the irradiation time of the ultraviolet rays in the step (e) and the radius of curvature of the edge portion according to the measurement result.

### DESCRIPTION OF THE PREFERRED EMBODIMENTS

Hereinafter, the present invention will be explained in detail with reference to embodiments and accompanied drawings.

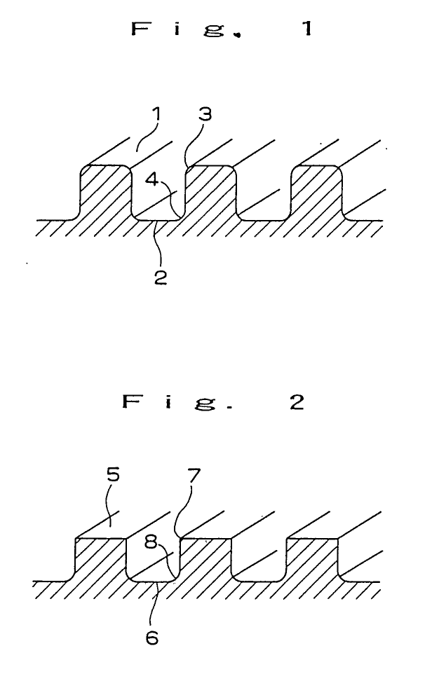

FIG. 1 is a magnified view showing a structure of lands and grooves of a magnetic super resolution recording medium (a magneto-optic disk) according to the present invention. In this magnetic super resolution recording medium, the edge portion 3 of the land 1 and the edge portion 4 of the groove 2 have a round shape without a keen edge. The radius of curvature is greater than one sixth of the width of the land or the groove. The maximum value of the radius of curvature is limited naturally by the width of the land 1 and groove 2.

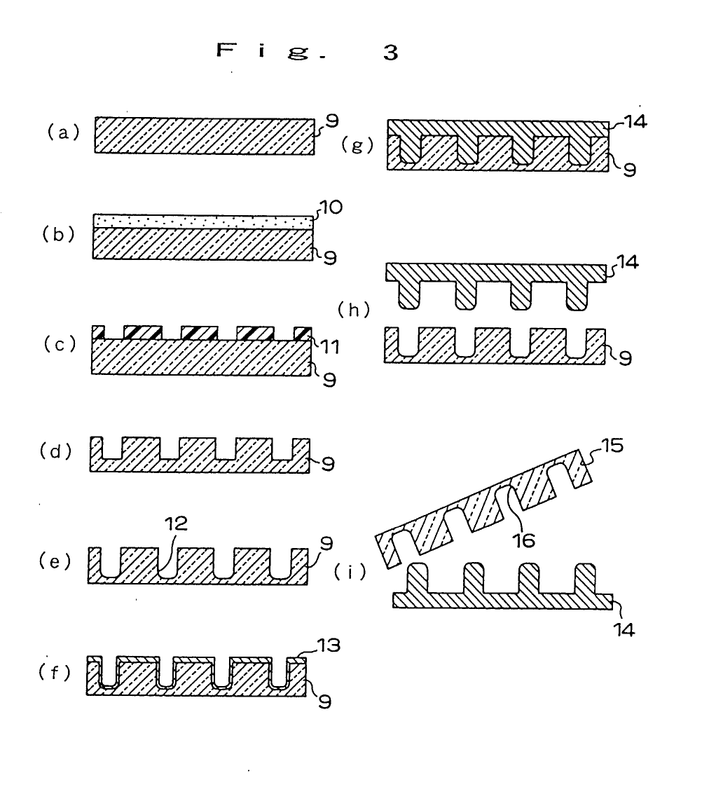

FIG. 2 is a magnified view showing another structure of lands and grooves of a magnetic super resolution recording medium according to the present invention. In this magnetic super resolution recording medium, the edge portion 7 of the land 5 has a rectangular section with a keen edge, while the edge portion 8 of the groove 6 has a round shape whose radius of curvature is greater than one sixth of the width of the land or the groove.

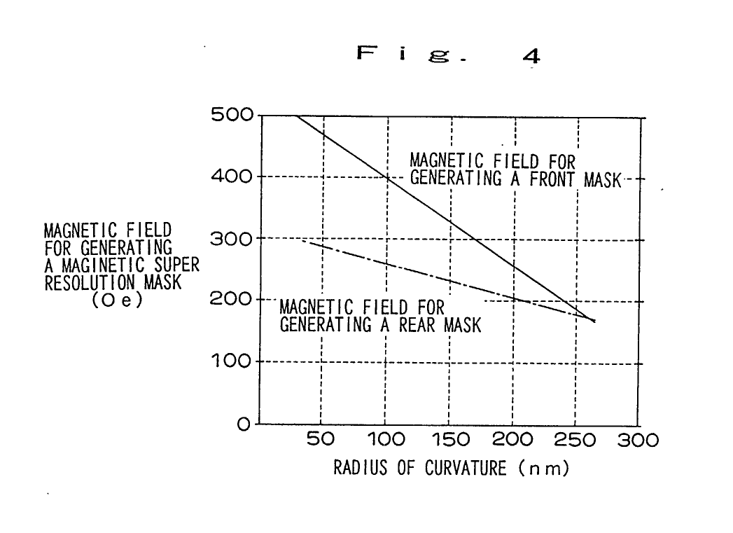

FIG. 3 shows a process for manufacturing a recording medium according to a first embodiment of the present invention.

First, in the step (a), a glass master disk 9 having a low surface roughness less than 50 angstroms is prepared.

In the step (b), the glass master disk 9 is coated with a positive type photoresist by spin-coating so as to form a resist film 10. The thickness of the resist film 10 is set to approximately 100 nm.

In the step (c), a pregroove writer is used for exposing the resist film 10 so that the land width (and the groove width) becomes 0.6 μm, and the resist film 10 is developed by a wet process. Thus, a resist pattern 11 whose land width and groove width are both 0.6 μm.

In the step (d), the resist pattern 11 is used as a mask for reactive ion etching (RIE) of the glass master disk 9. Preferably, a trifluoromethane (CHF₃) is used as an etching gas. The glass master disk 9 is etched by approximately 50 nm under the condition of gas pressure 0.5 Pa, flow rate 5 sccm, and RF power 200 W. However, this etching process is not limited to the above-mentioned condition. Other gas such as a tetrafluoromethane (CF₄) or an 8-fluoro butane (C₄F₈) can be used as the etching gas. After the etching, the residual resist pattern 11 is removed by an oxygen plasma ashing. As a result, pregrooves having a rectangular section as shown in (d) of FIG. 3 are formed on the glass master disk 9.

In the step (e), a spatter etching process is performed to the glass master disk 9 with the pregroove formed, using preferably an argon gas under the condition of gas pressure 0.5 Pa, flow rate 60 sccm and RF power 1 kW for approximately 10 minutes. As an effect of the spatter etching, the radius of curvature of the edge portion 12 of the groove is enlarged. By altering the etching condition, the increase of the radius of curvature can be controlled. Other gas such as CF₄, CHF₃ or C₄F₈, can be used as the etching gas.

In the step (f), maintaining the vacuum state of the step (e), a nickel thin film 13 is formed by spattering method to a thickness of approximately 50 nm.

In the step (g), an electroforming is performed by using the nickel thin film 13 as an electrode film so as to form a nickel film 14 having a thickness of approximately 300 μm.

In the step (h), the nickel film 14 is exfoliated from the glass master disk 9. Thus, a stamper 14 made of the nickel film is completed.

In the final step (i), the stamper 14 is used for making a replica disk 15 by an ultraviolet curable resin method (a 2 P method) or an injection molding method. Thus, the radius of curvature of the groove edge portion 16 of the replica disk 15 can be greater than one sixth of the width of the land or the groove.

The replica disk 15 is used as a substrate, on which a magnetic film having a three-layered structure is formed as disclosed in Japanese unexamined patent publication No. 7-244877. In this way, a magnetic super resolution recording medium that is a magneto-optic disk is manufactured, and the radius of curvature of the edge portion of the groove is greater than one sixth of the width of the land or the groove.

The magneto-optic disk that was manufactured by the above-mentioned process was measured by a magneto-optic disk tester (a wavelength of a light source is 685 nm, and a numerical aperture of an object lens is 0.55). The result of the measurement showed that the magnetic field necessary for forming the front mask in a groove is reduced substantially from the conventional 500 Oe to 180 Oe.

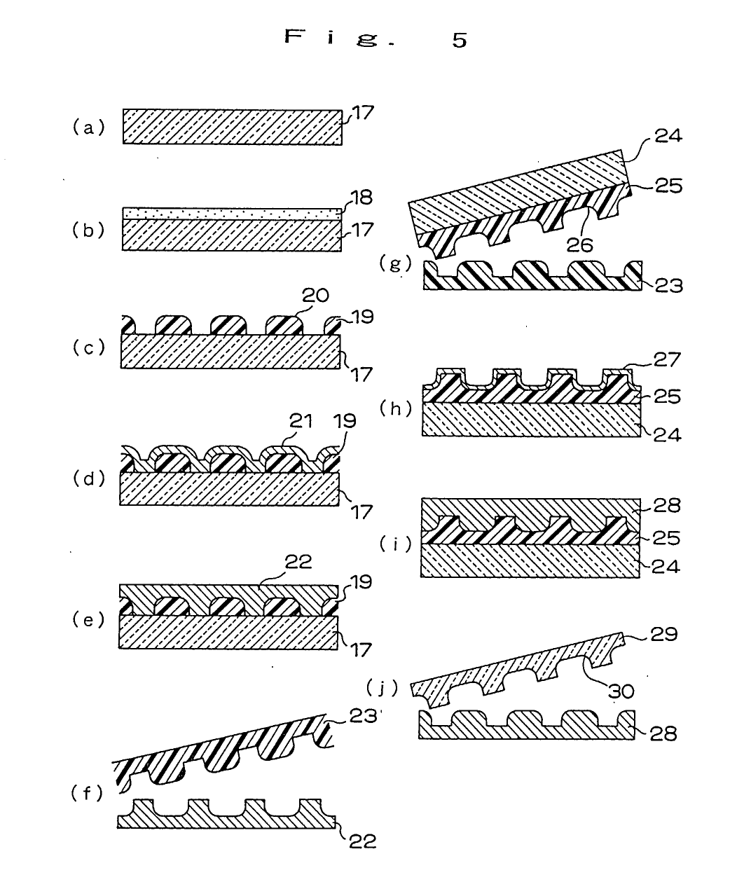

FIG. 4 is a graph showing a magnetic field for generating the front mask and the rear mask (magnetic super resolution masks) in the reproduction by the magnetic super resolution method when altering the radius of curvature of the edge portion of the groove. As understood from this graph, along with the increase of the radius of curvature, the magnetic field for generating particularly the front mask-is decreased. If the radius of curvature of the edge portion of the groove is greater than 100 nm, the magnetic field for generating the magnetic super resolution mask can be less than 400 Oe. Namely, since the manufactured magnetic super resolution medium has the land width (and the groove width) of 0.6 μm, the magnetic field for generating the magnetic super resolution mask can be less than 400 Oe by setting the radius of curvature of the edge portion of the groove to a value greater than one sixth of the width of the land (or the groove).

In addition, it is found that since the magnetic field for generating the magnetic super resolution mask is higher in a land than in a groove, the effect of reducing the magnetic field for generating the magnetic super resolution mask by enlarging the radius of curvature can be obtained more in a groove. Therefore, it is not always necessary to enlarge the radius of curvature of the edge portion both of the land and the groove. A sufficient effect may be obtained by enlarging the radius of curvature of the edge portion only of the groove.

Furthermore, if a pregroove pattern is formed on the glass master disk by reactive ion etching, the edge portions of the land and the groove become almost rectangular due to the effect of the anisotropic etching. Adding a spatter etching process under the condition of isotropic etching, the radius of curvature of the edge portion of the groove can be increased.

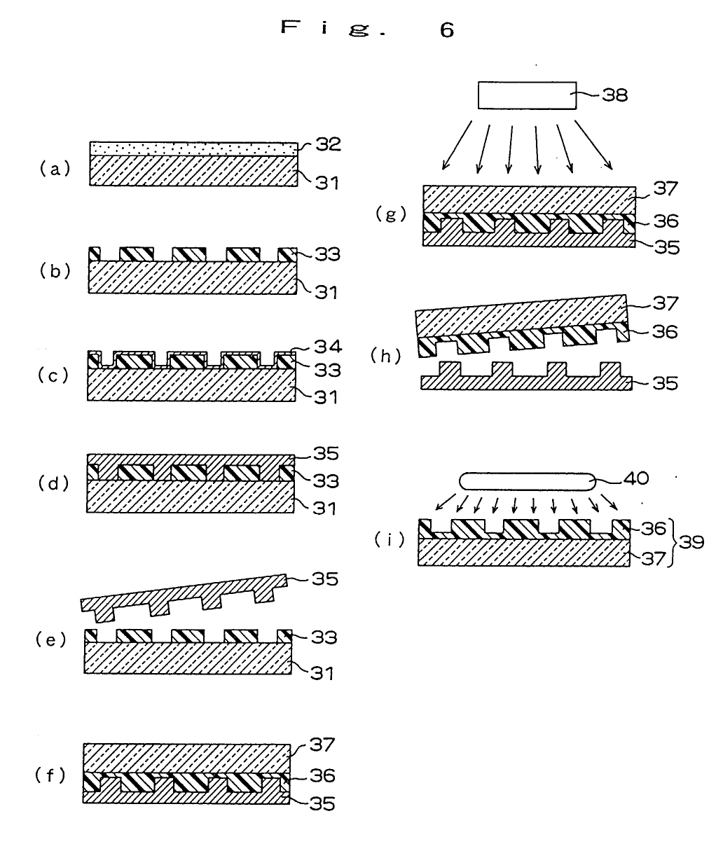

FIG. 5 shows a process for manufacturing a recording medium according to a second embodiment of the present invention.

First, in the step (a), a glass master disk 17 having a low surface roughness less than 50 angstroms is prepared.

In the step (b), the glass master disk 17 is coated with a positive type photoresist by spin-coating so as to form a resist film 18. The thickness of the resist film 18 is set to approximately 50 nm.

In the next step (c), a pregroove writer is used for exposing the resist film 18, which is then developed by a wet process. Thus, a resist pattern 19 is formed. Since the development by the wet process is an isotropic process including solution in a solvent, the resist pattern 19 generated by this process has a land whose radius of curvature of the edge portion 20 is enlarged.

In the step (d), a nickel thin film 21 having a thickness of approximately 50 nm is formed on the resist pattern 19 by using preferably a spattering method, a vapor deposition method or an electroless method.

In the step (e), the nickel thin film 21 is used as an electrode film for electroforming, so as to form a nickel film 22 having a thickness of approximately 300 μm. By exfoliating the nickel film 22 from the resist pattern 19, a stamper 22 made of the nickel film is completed.

In the next step (f), the stamper 22 is used for making an intermediate mold 23 by an ultraviolet curable resin method (i.e., a 2P method) or an injection molding method.

In the next step (g), the pitted surface pattern of the intermediate mold 23 is transferred to the ultraviolet curable resin 25 that is formed on a glass master disk 24.

In the next step (h), a nickel film 27 is formed on the pitted surface of the ultraviolet curable resin 25 by spattering.

In the next step (i), the nickel film 27 is used as an electrode for electroforming so as to form a nickel layer, which becomes a stamper 28.

In the final step (j), the stamper 28 is used for making a replica disk 29 by an ultraviolet curable resin method (i.e., a 2P method) or an injection molding method. Thus, the pitted surface pattern of the resist pattern 19 is transferred to the intermediate mold 23, and is further transferred to the stamper 28. Therefore, the land edge portion 20 having a large radius of curvature formed by the resist pattern 19 is transferred from the intermediate mold 23 to the groove edge portion 26 of the ultraviolet curable resin 25, and is further transferred to the groove edge portion 30 of the replica disk 29 that is made by the stamper 28.

The method for making the reverse image of the resist pattern that is formed by exposing and developing is not limited to the method of the above-mentioned embodiment.

In addition, another method for enlarging the radius of curvature of the edge portion of the land and the groove can be adopted, in which by the resist pattern 19 formed on the resist film 18 by using a pregroove writer is heated to the temperature close to the glass transition temperature of the resist material. As a result, the radii of curvature of the edge portions of the land and the groove of the resist pattern 19 increase, and the radii of curvature of the edge portions of the land and the groove of the stamper 22 made by using the resist pattern 19 increase. Then, the radii of curvature of the edge portions of the land and the groove of the replica disk made by using the stamper 22 increase.

In addition, the radii of curvature of the edge portions of the land and the groove can be increased by heating the replica disk made by using the stamper at the temperature that is lower than the glass transition temperature by approximately 10 degrees, too. The material of the replica disk is preferably a thermoplastic resin such as a polycarbonate or a polymethyl methacrylate (PMMA). The heating process is performed at the temperature of 130 degrees centigrade for approximately 12 hours.

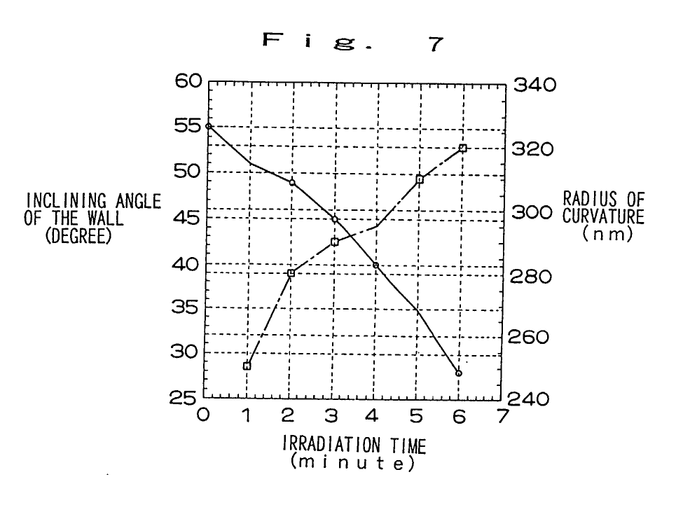

FIG. 6 shows a process for manufacturing a recording medium according to a third embodiment of the present invention.

First, in the step (a), a glass master disk 31 having a low surface roughness less than 50 angstroms is coated with a positive type photoresist by spin-coating so as to form a resist film 32. The thickness of the resist film 32 is set to approximately 50 nm.

In the step (b), a pregroove writer is used for exposing the resist film 32, which is then developed by a wet process. Thus, a resist pattern 33 is formed.

In the step (c), a nickel thin film 34 is formed on the resist pattern 33 by using a vapor deposition method. The thickness of the nickel thin film 34 is set to approximately 50 nm.

In the step (d), the nickel thin film 34 is used as an electrode film for electroforming, so as to form a nickel film 35 having a thickness of approximately 300 μm.

In the step (e), the nickel film 35 is exfoliated from the glass master disk 31 and the resist pattern 33, so that a stamper 35 is completed.

In the step (f), the stamper 35 is used as a mother mold, whose pitted surface is coated with an ultraviolet curable resin 36, which a glass master disk 37 contacts. The thickness of the ultraviolet curable resin 36 between the stamper 35 and the glass master disk 37 is set to approximately 30 μm.

In the step (g), the stamper 35, the ultraviolet curable resin 36 and the glass master disk 37 that are contacted to each other are irradiated by ultraviolet rays emitted from the ultraviolet ray irradiation apparatus 38 so that the ultraviolet curable resin 36 is cured.

In the step (h), exfoliating the stamper 35, a transfer glass master disk 39 is completed that includes the glass master disk 37 and the ultraviolet curable resin 36 having the pitted surface.

In the step (i), the above-mentioned transfer glass master disk 39 is set in an ultraviolet ray irradiation apparatus including a low voltage mercury lamp 40. The transfer glass master disk 39 is irradiated with ultraviolet rays having a wavelength below 254 μm emitted from the low voltage mercury lamp 40 at the ultraviolet curable resin 36 side for approximately two minutes. Preferably, the distance between the transfer glass master disk 39 and the low voltage mercury lamp 40 is set to approximately 10 mm.

By this irradiation process with ultraviolet rays, the radius of curvature of the edge portion of the pitted surface of the transfer glass master disk 39 (i.e., the pitted surface of the ultraviolet curable resin 36) is enlarged. The reason is considered to be that the ultraviolet rays generate ozone that etches the edge portion of the ultraviolet curable resin 36.

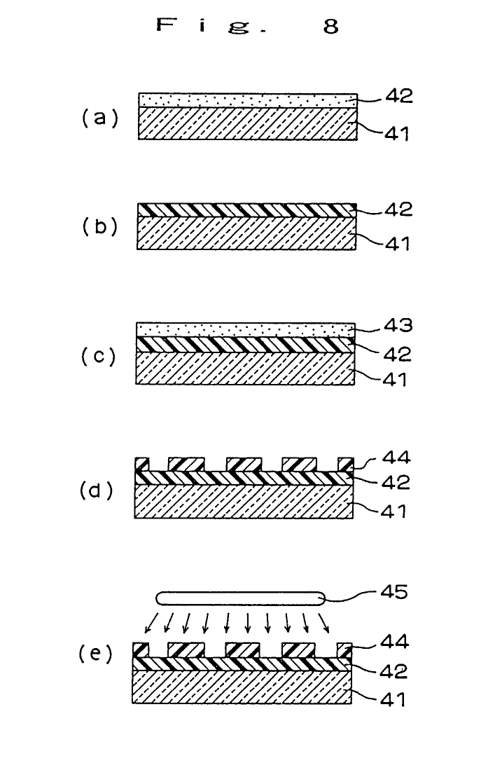

FIG. 7 is a graph that shows the relationship between the irradiation time of the ultraviolet rays in the step (i) and the radius of curvature of the edge portion or an inclining angle of the wall. As understood from this graph, along with the increase of the irradiation time of the ultraviolet rays, the radius of curvature (shown in a chain line) of the edge portion increases, while the inclining angle of the wall (shown in a solid line) decreases (i.e., becomes gentle). In this result of measurement, the radius of curvature of the edge portion is approximately 280 nm and the angle of the wall is approximately 49 degrees when the irradiation time of the ultraviolet rays is two minutes.

The following steps of making a stamper, making a replica disk by using the stamper and making a magneto-optic disk are the same as those explained in the first embodiment (the step (f) and the following steps in FIG. 3). It was verified that the magneto-optic disk manufactured by the process of this embodiment also enable the external magnetic field for generating the front mask in the groove to decrease to 180 Oe in the same way as the first embodiment.

As a variation of the above-mentioned third embodiment, the glass master disk 37 in the step (f) and the following steps can be omitted by increasing the thickness of the ultraviolet curable resin 36 up to approximately 6 mm. In this case, the ultraviolet curable resin 36 may be cured by the irradiation with the ultraviolet rays for approximately four minutes. When the thickness of the ultraviolet curable resin is increased up to approximately 6 mm, the problem about the strength does not occur without the glass master disk 37. After the ultraviolet curable resin is cured, the stamper 35 is exfoliated and the obtained ultraviolet curable resin master disk is used for performing the step (i) and the following steps in FIG. 3.

As another variation of the above-mentioned third embodiment, the ultraviolet curable resin 36 used in the step (f) and the following steps can be replaced with a thermoplastic resin such as a polycarbonate. In this case too, if the thickness of the thermoplastic resin 36 is increased up to approximately 6 mm so as to increase the strength, the glass master disk 37 can be omitted. In the concrete steps, the stamper 35 made in the step (e) is attached to an injection molding machine, and a polycarbonate resin is injected so as to produce a resin mold having a thickness of approximately 6 mm. Then, the stamper 35 is exfoliated and the obtained resin mold master disk is used for performing the step (i) and the following steps in FIG. 3. The material of the resin mold is not limited to a polycarbonate, but other thermoplastic resin that is suitable for duplicating a fine shape can be used. A thermosetting resin can be also used for resin molding.

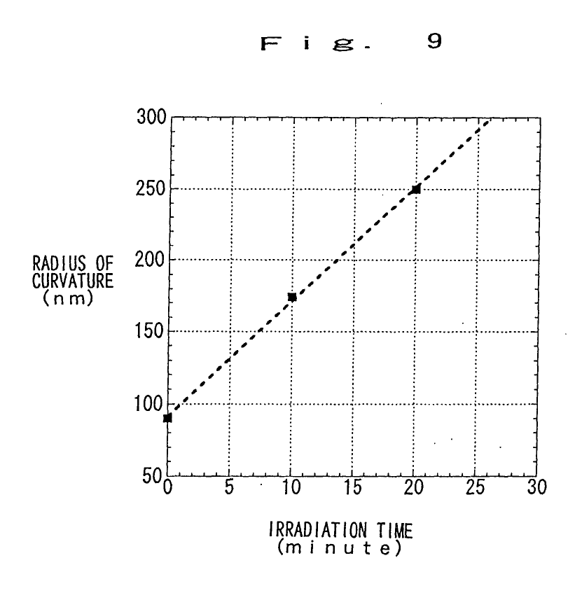

FIG. 8 shows a process for manufacturing a recording medium according to a fourth embodiment of the present invention.

First, in the step (a), a glass master disk 41 is coated with a photoresist by spin-coating so as to form an intermediate layer 42.

In the step (b), baking in an oven is performed at the temperature of 180° C. for 60 minutes. Thus, the intermediate layer is not mixed with the photoresist thereover for forming the pitted surface layer and loses the photosensitivity.

In the step (c), the glass master disk 41 is coated with a photoresist for forming a pitted surface up to the thickness of 50 nm so as to form a resist film 43. The material of the photoresist used for the intermediate layer 42 and that for the resist film 43 is the same. For example, Tokyo Ouka Corporation THMR-iP3300 can be used for them.

In the step (d), after prebaking at the temperature of 100° C. for 30 minutes, exposing and developing are performed so as to form a pitted surface layer 44. This pitted surface layer 44 is baked under the same condition as the intermediate layer so as to gain a surface strength that is similar to that of the intermediate layer. Though this step can be omitted, it is preferable to include the step.

In the step (e), the above-mentioned master disk including the glass master disk 41, the intermediate layer 42 and the pitted surface layer 44 is set in the ultraviolet ray irradiation apparatus including a low voltage mercury lamp 45. The master disk is irradiated with ultraviolet rays having a wavelength below 254 μm emitted from the low voltage mercury lamp 45 at the pitted surface layer 44 side for approximately 20 minutes. Preferably, the distance between the master disk and the low voltage mercury lamp 45 is set to approximately 10 mm.

By this irradiation process with ultraviolet rays, the radius of curvature of the edge portion of the pitted surface layer 44 is enlarged. The reason is considered to be that the ultraviolet rays generate ozone that etches the edge portion of the pitted surface layer 44.

FIG. 9 is a graph that shows the relationship between the irradiation time of the ultraviolet rays in the step (e) and the radius of curvature of the edge portion according to the measurement result. As understood from this graph, along with the increase of the irradiation time of the ultraviolet rays, the radius of curvature of the edge portion increases.

The following steps of making a stamper, making a replica disk by using the stamper and making a magneto-optic disk are the same as those explained in the first embodiment (the step (f) and the following steps in FIG. 3). The radius of curvature of the edge portion in the pitted surface manufactured by this embodiment was approximately 250 nm. It was verified that the magneto-optic disk manufactured by the process of this embodiment also enable the external magnetic field for generating the front mask in the groove to decrease to 180 Oe in the same way as the first embodiment.

In addition, the process of this embodiment has an advantage to the first or the second embodiment in that the depth of the pits formed in an ID portion of the recording medium can be controlled easily. Namely, the independent control of the depth of the groove and the pits in the recording area or the formation of different depths of pits is difficult in the first or the second embodiment, but is easy in this embodiment.

As a variation of the above-mentioned the fourth embodiment, the intermediate layer 42 in the step (a) of FIG. 8 can be formed by using an ultraviolet curable resin instead of the photoresist. In an example, an ultraviolet curable resin was applied uniformly up to the thickness of 30 μm, and was irradiated with ultraviolet rays having the wavelength of 365 nm for approximately four minutes so as to cure the ultraviolet curable resin. After that, the same steps as the step (c) and the following steps in FIG. 8 were performed. In this case too, the same effect as the fourth embodiment can be obtained.

As another variation of the above-mentioned the fourth embodiment, the irradiation with the ultraviolet rays in the step (e) of FIG. 8 can be replaced with spatter etching. In the same way as the ozone etching by the ultraviolet rays, the radius of curvature of the edge portion of the pitted surface layer 44 can be enlarged. In an example, an argon gas was used for spatter etching under the condition of gas pressure 0.5 Pa, flow rate 60 sccm, and RF power 1 kW for five minutes. After that, the same steps as the step (c) and the following steps in FIG. 8 were performed. In this case too, the same effect as the fourth embodiment can be obtained.

The above-mentioned two variations can be combined. Namely, the intermediate layer 42 in the step (a) of FIG. 8 was formed by using an ultraviolet curable resin, and the irradiation with the ultraviolet rays in the step (e) of FIG. 8 was replaced with the spatter etching under the condition mentioned above. In this case too, the same effect as the fourth embodiment can be obtained.

As still another variation of the above-mentioned the fourth embodiment, the step (d) of FIG. 8 can be followed by a heating process of the master disk at the temperature of 270° C. that is close to the glass transition temperature of the resist material for 30 minutes. Thus, the radius of curvature of the edge portion of the pitted surface layer 44 is enlarged. Therefore, the irradiation with the ultraviolet rays in the step (e) of FIG. 8 can be omitted. In this case too, the same effect as the fourth embodiment can be obtained.

As explained above, in the recording medium of the present invention, at least one of the land and the groove (preferably the groove) has an edge portion whose radius of curvature is greater than one sixth of the width of the land or the groove. Thus, the intensity of a magnetic field for generating a magnetic super resolution mask can be reduced to a value less than 400 Oe.

The present invention also provides various kinds of processes suitable for manufacturing the above-mentioned recording medium.

While the presently preferred embodiments of the present invention have been shown and described, it will be understood that the present invention is not limited thereto, and that various changes and modifications may be made by those skilled in the art without departing from the scope of the invention as set forth in the appended claims.

What is claimed is:

1. A recording medium having lands and grooves formed on a substrate, both the land and the groove being used for recording information, wherein at least one of the land and the groove has an edge portion whose radius of curvature is greater than one sixth of the width of the land or the groove.

2. A process for manufacturing a recording medium, comprising the steps of:
forming a resist pattern on a substrate that can be processed by plasma etching utilizing a photolithography method;
using the resist pattern as a mask for dry etching;
etching the substrate by spattering after removing a residual resist pattern so as to enlarge a radius of curvature of an edge portion of a groove:
making a stamper to which the shape of the etching pattern is transferred;
making a substrate of a recording medium using the stamper; and
forming a recording film on the substrate of the recording medium.

3. A process for manufacturing a recording medium, comprising the steps of:
forming a resist pattern on a substrate utilizing a photolithography method;
deforming the resist pattern by heat;
making a stamper to which the shape of the resist pattern is transferred;
using the stamper for making a substrate of a recording medium; and
forming a recording film on the substrate of the recording medium.

4. A process for manufacturing a recording medium, comprising the steps of:
forming a resist pattern on a substrate that can be processed by plasma etching utilizing a photolithography method;
using the resist pattern as a mask for dry etching;
etching the substrate by spattering after removing a residual resist pattern so as to enlarge a radius of curvature of an edge portion of a groove:
making a first stamper to which the shape of the etching pattern is transferred;
making a second stamper to which the shape of the first stamper is transferred;
using the second stamper for making a substrate of a recording medium; and
forming a recording film on the substrate of the recording medium.

5. A process for manufacturing a recording medium, comprising the steps of:
forming a resist pattern on a substrate utilizing a photolithography method;
deforming the resist pattern by heat;
making a first stamper to which the shape of the resist pattern is transferred;
making a second stamper to which the shape of the first stamper is transferred;
using the second stamper for making a substrate of a recording medium; and
forming a recording film on the substrate of the recording medium.

6. A process for manufacturing a recording medium, comprising the steps of:
irradiating a master disk having a pitted surface shape with ultraviolet rays so as to enlarge a radius of curvature of an edge portion of the pitted surface shape;
using the master disk having the enlarged radius of curvature at the edge portion so as to make a stamper;
using the stamper for making a substrate of a recording medium; and
forming a recording film on the substrate of the recording medium.

7. The process according to claim 6, wherein the master disk is manufactured by the process comprising the steps of:
forming a pitted surface shape on a resist pattern utilizing a photolithography method;
forming an electrode film on the pitted surface;
making a stamper by electroforming with the electrode film; and
using the stamper for transferring the pitted surface shape to an ultraviolet curable resin.

8. The process according to claim 6, wherein the master disk is manufactured by the process comprising the steps of:
forming a pitted surface shape on a resist pattern utilizing a photolithography method;
forming an electrode film on the pitted surface;
making a stamper by electroforming with the electrode film; and
using the stamper for transferring the pitted surface shape by resin molding.

9. A process for manufacturing a recording medium, comprising the steps of:
applying a photoresist on a substrate and making an intermediate layer by performing a predetermined deactivation process to the photoresist;
applying another photoresist to be a pitted surface layer on the intermediate layer;
forming a pitted surface shape on the pitted surface layer utilizing a photolithography method;
enlarging a radius of curvature of an edge portion of the pitted surface shape by a predetermined process;
making a stamper by using a master having the edge portion of the pitted surface shape whose radius of curvature was enlarged;
using the stamper for making a substrate of a recording medium; and
forming a recording film on the substrate of the recording medium.

10. The process according to claim 9, wherein the deactivation process is a baking process under a temperature higher than the pre-baking temperature, whereby the intermediate layer changes the properties so as not to be mixed with the photoresist of the pitted surface layer and so as to lose the photosensitivity.

11. The process according to claim 10, further comprising the step of performing a baking process to the pitted surface layer after forming the pitted surface shape of the resist pattern, the baking process being the same as that of the deactivation process.

12. A process for manufacturing a recording medium, comprising the steps of:
applying an ultraviolet curable resin on a substrate and making an intermediate layer by curing the resin;
applying a photoresist to be a pitted surface layer on the intermediate layer;
forming a pitted surface shape on the pitted surface layer utilizing a photolithography method;
enlarging a radius of curvature of an edge portion of the pitted surface shape by a predetermined process;
making a stamper by using a master having the edge portion of the pitted surface shape whose radius of curvature was enlarged;
using the stamper for making a substrate of a recording medium; and
forming a recording film on the substrate of the recording medium.

13. The process according to claim 9, wherein the exposed surface of the intermediate layer is also processed in the process for enlarging the radius of curvature of the edge portion of the pitted surface.

14. The process according to claim 12, wherein the exposed surface of the intermediate layer is also processed in the process for enlarging the radius of curvature of the edge portion of the pitted surface.

15. The process according to claim 9, wherein the process for enlarging the radius of curvature of the edge portion of the pitted surface is an ozone etching process.

16. The process according to claim 12, wherein the process for enlarging the radius of curvature of the edge portion of the pitted surface is an ozone etching process.

17. The process according to claim 9, wherein the process for enlarging the radius of curvature of the edge portion of the pitted surface is a spatter etching process.

18. The process according to claim 12, wherein the process for enlarging the radius of curvature of the edge portion of the pitted surface is a spatter etching process.

19. The process according to claim 9, wherein the process for enlarging the radius of curvature of the edge portion of the pitted surface is a heating process at a temperature close to the glass transition temperature.

20. The process according to claim 12, wherein the process for enlarging the radius of curvature of the edge portion of the pitted surface is a heating process at a temperature close to the glass transition temperature.
